(19) United States
(12) Patent Application Publication
(10) Pub. No.: US 2025/0319461 A1
(43) Pub. Date: Oct. 16, 2025

(54) SELF-SUPPORTED HYDROPROCESSING CATALYST FINES FOR RENEWABLE FUEL PRODUCTION IN SLURRY PLATFORM

(71) Applicant: CHEVRON U.S.A. INC., San Ramon, CA (US)

(72) Inventors: Shuwu YANG, Richmond, CA (US); Bo KOU, Albany, CA (US); Goutam BISWAS, Danville, CA (US); Michelle K. YOUNG, Manvel, TX (US); Theodorus Ludovicus Michael MAESEN, Spring, TX (US)

(21) Appl. No.: 19/175,606

(22) Filed: Apr. 10, 2025

Related U.S. Application Data
(60) Provisional application No. 63/632,714, filed on Apr. 11, 2024.

(51) Int. Cl. B01J 37/20; B01J 27/04; B01J 35/40; B01J 37/00

(52) U.S. Cl. CPC B01J 37/20; B01J 27/04; B01J 35/40; B01J 37/0036; B01J 37/0072

(57) ABSTRACT

A method is disclosed for preparing a slurry catalyst for use in upgrading a renewable feedstock. The method includes the steps of (a) providing a rework material obtained from a process of making a self-supported hydroprocessing catalyst, the hydroprocessing catalyst containing one or more active metal components selected from the group consisting of Group 6-12 metals from the IUPAC Periodic Table of the Elements, wherein the rework material has an average particle size of from 1 to 300 μm; (b) mixing the rework material with a liquid component to form a slurry catalyst precursor, wherein the liquid component is selected from the renewable feedstock and a liquid carrier, wherein the liquid carrier is a polyol and/or a recycled renewable feedstock comprising heavy and/or unconverted fractions from a slurry hydroprocessing process; and (c) sulfiding the slurry catalyst precursor forming the slurry catalyst.

### CROSS-REFERENCE TO RELATED APPLICATION

This application claims priority to and the benefit of U.S. Provisional Application No. 63/632,714 having a filing date of Apr. 11, 2024, the disclosure of which is incorporated herein by reference in its entirety.

### FIELD

The present disclosure relates to a method for making a catalyst and a process for slurry hydroprocessing of renewable feedstocks in the presence of the catalyst to provide usable products and further prepare feedstocks for further refining.

### BACKGROUND

As the demand for transportation fuels increases worldwide, there is increasing interest in feedstock sources other than petroleum crude oil. Biomass offers a source of renewable carbon and refers to biological material derived from living or deceased organisms and includes lignocellulosic materials (e.g., wood), aquatic materials (e.g., algae, aquatic plants, and seaweed) and animal by-products and wastes (e.g., offal, fats, and sewage sludge). Liquid transportation fuels produced from biomass are sometimes referred to as biofuels. Therefore, when using such biofuels, it may be possible to achieve more sustainable CO-emissions compared with petroleum-derived fuels.

Slurry hydroprocessing provides an attractive method for conversion of solid or difficult liquid renewable feedstocks into higher value liquid products. Slurry-phase hydroprocessing typically employs dispersed metal compounds as catalysts. Conventional dispersed catalysts are nanosized transition metal sulfides, which have low diffusion resistance and can be continuously recycled and refreshed. Unfortunately, the catalysts themselves tend to be expensive and difficult to manufacture. For these reasons, the development of more inexpensive alternative catalysts is desired.

### SUMMARY

In a first aspect, the present disclosure relates to a method for preparing a slurry catalyst for use in upgrading a renewable feedstock, comprising: (a) providing a rework material obtained from a process of making a self-supported hydroprocessing catalyst, the hydroprocessing catalyst containing one or more active metal components selected from the group consisting of Group 6-12 metals from the IUPAC Periodic Table of the Elements, wherein the rework material has an average particle size of from 1 to 300 μm; (b) mixing the rework material with a liquid component to form a slurry catalyst precursor, wherein the liquid component is selected from the renewable feedstock and a liquid carrier, wherein the liquid carrier is a polyol and/or a recycled renewable feedstock comprising heavy and/or unconverted fractions from a slurry hydroprocessing process; and (c) sulfiding the slurry catalyst precursor forming the slurry catalyst.

In a second aspect, the present disclosure relates to a process for upgrading a renewable feedstock, the process comprising: (a) contacting in a slurry hydroprocessing unit the renewable feed with a slurry catalyst composition comprising: (i) a rework material obtained from a process of making a self-supported hydroprocessing catalyst, the hydroprocessing catalyst containing one or more active metal components selected from the group consisting of Group 6-12 metals from the IUPAC Periodic Table of the Elements, wherein the rework material has an average particle size of from 1 to 300 μm, and (ii) a liquid component, wherein the liquid component is selected from the renewable feedstock and a liquid carrier, wherein the liquid carrier is a polyol and/or a recycled renewable feedstock comprising heavy and/or unconverted fractions from a slurry hydroprocessing process; and (b) hydroprocessing the renewable feed in the slurry hydroprocessing unit to produce an upgraded renewable feed.

### DETAILED DESCRIPTION

### Definitions

The term “hydroprocessing” refers to any process that is carried out in the presence of hydrogen and a catalyst. Such processes include, but are not limited to, hydrogenation, hydrotreating, hydrodesulfurization, hydrodenitrogenation, hydrodeoxygenation, hydrodemetallation, hydrodearomatization, hydroisomerization, hydrodewaxing, hydrocracking, methanation, and water gas shift reactions.

The term “slurry” means a mixture of liquid and solid.

The term “rework” may be used interchangeably with “rework materials” or “catalyst fines”, referring to catalyst products, scrap pieces, fines, and/or rejected materials obtained from the process of making a calcined supported hydroprocessing catalyst composition.

In this discussion, the terms “catalyst” and “catalyst precursor” are both used. During formation of a slurry catalyst, a self-supported catalyst can be formed. After drying, the metals can remain self-supported. At this stage, the composition corresponds to/is defined as a “catalyst precursor” for purposes of the claims below. Prior to use for hydroprocessing, the catalyst precursor can be sulfided, which converts the metals to metal sulfides. After sulfidation, the composition corresponds to/is defined as a “catalyst” for purposes of the claims below. It is noted that to simplify the language used for describing preparation of a catalyst, the term “catalyst” may be used informally to refer to compositional states prior to sulfidation, even though the “catalyst” corresponds to only the final sulfided composition.

The term “self-supported”, used in this specification when describing a mixed metal oxide or sulfide catalyst composition, indicates that the catalyst composition is self-supporting in that it does not require a carrier or support. The self-supported catalysts may have some minor amount of carrier or oxidic support material in their compositions (e.g., 20 wt. % or less, 15 wt. % or less, 10 wt. % or less, 5 wt. % or less, or substantially no carrier or support, based on the total weight of the catalyst composition). For instance, self-supported hydroprocessing catalyst comprising mostly metal sulfides may contain a minor amount of a binder (e.g., to improve the physical and/or thermal properties of the catalyst). In contrast, supported catalyst systems typically comprise a carrier or support onto which one or more catalytically active materials are deposited, often using an impregnation or coating techniques. Nevertheless, solid catalyst systems without an oxidic or carbonaceous carrier or support (or with a minor amount of carrier or support) are generally referred to as self-supported catalysts and are frequently formed by co-precipitation or co-gelation techniques.

“Average particle size” is synonymous with D50, meaning half of the population of particles has a particle size above this point, and half below. Particle size refers to primary particles. Particle size may be measured by laser light scattering techniques, with dispersions or dry powders, for example according to ASTM D4464.

### Rework Material

The slurry catalyst may be prepared from a powder as metal precursor feedstock (e.g., rework material). Suitable rework materials include catalyst fines generated in the making of (unsulfided) self-supported (e.g., mixed Group 6 and Group 8 metals) catalyst precursors used for hydroconversion processes known in the art. In one embodiment, the rework material is from a regenerated or recycled particulate catalyst.

Rework materials for use as metal precursor feed may comprise scrap/discarded/unused materials generated in any step of the preparation of (unsulfided) self-supported hydroprocessing catalyst precursors. Rework can be generated from any of the forming, drying, or shaping of the catalyst precursors, or formed upon the breakage or handling of the catalyst precursor in the form of pieces or particles (e.g., fines, powder, and the like). In the process of making catalyst precursors (e.g., by spray drying, pelleting, pilling, granulating, beading, tablet pressing, bricketting, using compression methods via extrusion or other means known in the art or by the agglomeration of wet mixtures, forming shaped catalyst precursors), rework material is generated.

The self-supported hydroprocessing catalyst for use as rework material contains one or more active metal components selected from the group consisting of Group 6-12 metals from the IUPAC Periodic Table of the Elements, for example transition metals such as molybdenum (Mo), tungsten (W), iron (Fe), nickel (Ni), cobalt (Co), and zinc (Zn). In certain embodiments, the active metal component of the self-supported hydroprocessing catalyst is a combination of active metal components selected from the group consisting of nickel-tungsten, nickel-molybdenum, nickel-molybdenum-tungsten, cobalt-molybdenum, and iron-zinc. Self-supported metal catalyst precursors can be metal oxides, hydroxides, or oxyhydroxides that are converted to sulfided form by contacting with a sulfiding medium such as hydrogen sulfide as is conventionally known.

The self-supported hydroprocessing catalyst may further include a binder. Non-limiting examples of suitable binder materials can include silica, silica-alumina (e.g., conventional silica-alumina, silica-coated alumina, alumina-coated silica, or the like, or a combination thereof), alumina (e.g., boehmite, pseudo-boehmite, gibbsite, or the like, or a combination thereof), titania, zirconia, cationic clays or anionic clays (e.g., saponite, bentonite, kaolin, sepiolite, hydrotalcite, or the like, or a combination thereof), cellulose, lignocellulose, lignin, graphite, carbon nanotubes, buckminsterfullerene, synthetic polymers (e.g., polyolefins, polyesters or other plastics) and combinations thereof. In some preferred embodiments, the binder can include silica, silica-alumina, alumina, titania, niobia, zirconia, and mixtures thereof. Binder amounts up to 25 wt. % of the total composition can be suitable (when present, from above 0 wt. % to 25 wt. %). However, binder amounts, when added, can generally be from 0.5 wt. % to 20 wt. % of the total catalyst composition.

Rework materials may be generated from commercially available self-supported hydroprocessing catalysts reduced to an average particle size of 300 μm or less. Examples of suitable hydroprocessing catalysts include one or more of ICR® 1000 series catalyst available from Advanced Refining Technologies, such as one or more of ICR 1000 and ICR 1003; and bulk-metal catalysts available from ExxonMobil under the trademarks Nebula® and Celestia™.

While not limited thereto, the rework material can be characterized by an average particle size that ranges from 1 to 300 μm, such as from 1 to 100 μm, from 1 to 50 μm, from 1 to 25 μm, from 2 to 300 μm, from 2 to 100 μm, from 2 to 50 μm, from 2 to 25 μm, from 5 to 300 μm, from 5 to 100 μm, from 5 to 50 μm, from 5 to 25 μm, or from 10 to 30 μm, and the like.

The rework material can be ground, pulverized, or crushed to the desired particle size using techniques known in the art (e.g., via wet grinding or dry grinding) and using equipment known in the art including but not limited to hammer mill, roller mill, ball mill, jet mill, attrition mill, grinding mill, media agitation mill, etc.

The rework material can have a total pore volume of 0.1 cm³/g or more (e.g., 0.2 cm³/g or more, 0.3 cm³/g or more, 0.4 cm³/g more, or 0.5 cm³/g) and/or 1.2 cm³/g or less (e.g., 1.1 cm³/g or less, 1.0 cm³/g or less 0.9 cm³/g or less, 0.8 cm³/g or less, 0.7 cm³/g or less, or 0.6 cm³/g or less). The total pore volume may be determined by mercury porosimetry in accordance with ASTM D6761.

The rework material can have a Brunauer-Emmett-Teller (BET) specific surface area of 30 m²/g or more (e.g., 50 m²/g or more, 100 m²/g or more, 200 m²/g or more, 300 m²/g or more, or 400 m²/g or more) and/or 500 m²/g or less (e.g., 400 m²/g or less, 300 m²/g or less, 200 m²/g or less, 100 m²/g or less, or 50 m²/g or less). The BET specific surface area may be determined by nitrogen adsorption according to ASTM D3663.

The rework material (i.e., fresh self-supported hydroprocessing catalyst) may be mixed with a ground spent self-supported hydroprocessing catalyst to produce a rework material mixture. The spent hydroprocessing catalyst may be a spent hydroprocessing catalyst from fossil-fuel applications. Advantageously, the spent hydroprocessing catalyst, before the grinding and the mixing with fresh hydroprocessing catalyst, is subjected to a thermal treatment under an oxygen-containing atmosphere at from 400° C. to 1000° C. (e.g., 400° C. to 600° C.). Appropriately, the thermal treatment is carried out for a period of from 30 minutes to 10 hours, preferably for a period of from 1 to 3 hours. The spent hydroprocessing catalyst is advantageously, if appropriate after a thermal treatment, ground in suitable mills. The average particle size of the ground spent hydroprocessing catalyst can range from 1 to 300 μm (e.g., 1 to 100 μm, or 2 to 50 μm). The ground spent hydroprocessing catalyst may be mixed with the fresh hydroprocessing catalyst in a weight ratio of ground spent hydroprocessing catalyst:fresh hydroprocessing catalyst of 1:99 to 10:90.

Spent hydroprocessing catalyst may be used as a low-cost scavenger for “dirty” feeds. The term “fresh” when used in connection with the self-supported hydroprocessing catalyst herein means the catalyst has not been used in a catalytic reaction after being manufactured. A “spent” catalyst is used herein generally to describe a used catalyst that has unacceptable performance in one or more of catalyst activity, hydrocarbon feed conversion, yield to a desired product(s), selectivity to a desired product(s), or an operating parameter, such as maximum operating temperature or pressure drop across a reactor, although the determination that a catalyst is “spent” is not limited only to these features. The unacceptable performance of the spent catalyst can be due to a carbonaceous build-up on the catalyst over time but is not limited thereto. A “deactivated” or “poisoned” catalyst has substantially no catalytic activity. A spent catalyst can be contacted with a catalyst poisoning agent, which effectively kills the activity of the resultant deactivated or poisoned catalyst. In some aspects, the “fresh” catalyst can have an activity X, the “spent” catalyst can have an activity Y, and the “deactivated” catalyst or “poisoned” catalyst can have an activity Z, such that Z<Y<X. Thus, the activity of the spent catalyst is less than that of the fresh catalyst, but greater than that of the deactivated/poisoned catalyst (which can have no measurable catalyst activity). Catalyst activity comparisons (e.g., yield, selectivity) are meant to use the same production run (batch) of catalyst, tested on the same equipment, and under the same test method and conditions.

In some embodiments, the rework material (i.e., fresh self-supported hydroprocessing catalyst) may be mixed with a ground supported hydroprocessing catalyst to produce a rework material mixture. The supported hydroprocessing catalyst may be fresh, spent, or a combination thereof. The supported hydroprocessing catalyst is advantageously, ground in suitable mills. The average particle size of the ground supported hydroprocessing catalyst can range from 1 to 300 μm (e.g., 1 to 100 μm, or 2 to 50 μm). The ground supported hydroprocessing catalyst may be mixed with the fresh self-supported hydroprocessing catalyst in a weight ratio of ground supported hydroprocessing catalyst:fresh self-supported hydroprocessing catalyst of 1:99 to 10:90.

### Method for Making Slurry Catalyst

A slurry catalyst may be prepared by mixing the rework material with a liquid component to form an unsulfided slurry catalyst precursor and sulfiding the slurry catalyst precursor to form the slurry catalyst.

The liquid component may be a renewable feedstock, a liquid carrier, or a combination thereof.

The rework material may be dispersed in either the renewable feedstock or the liquid carrier. The rework material may also be dispersed in both the renewable feedstock and the liquid carrier.

The liquid carrier may be selected from a polyol, a recycled renewable feedstock, or a combination thereof.

The polyol may be selected from ethylene glycol, diethylene glycol, triethylene glycol, polyethylene glycol, propylene glycol, dipropylene glycol, tripropylene glycol, polypropylene glycol, butylene glycol, propanediol, butanediol, glycerol, and combinations thereof.

In one embodiment, the polyethylene glycol comprises or consists of a polyethylene glycol having a number average molecular weight (Mn) of less than 1000 or a mixture thereof. Examples of polyethylene glycols suitable for use herein include polyethylene glycol 200, polyethylene glycol 300, polyethylene glycol 400, polyethylene glycol 500, polyethylene glycol 600, polyethylene glycol 700, polyethylene glycol 800, polyethylene glycol 900, and mixtures thereof. In one embodiment the polyethylene glycol is polyethylene glycol 400 or polyethylene glycol 600, or a mixture thereof. In one particular embodiment, the polyethylene glycol is polyethylene glycol 400. In one particular embodiment, the polyethylene glycol is polyethylene glycol 600.

The recycled feedstock may be a renewable feedstock obtained from the slurry hydroprocessing process disclosed herein, or recycled from other processes in a refinery where the slurry hydroprocessing process takes place. Examples of recycled feedstock include heavy and/or unconverted fractions from the slurry hydroprocessing process, or from other processes in the refinery such as bio-residual oil from a biodiesel-making process.

In one embodiment, rework material is employed as a powder in an amount sufficient for the formation of the slurry catalyst and to provide a slurry catalyst dosage of 5 to 5000 ppm total active component (e.g., Mo, Mo—Ni) to total renewable feedstock. The amount of powder (i.e., rework materials) can range from 1 to 60 wt. % of total weight of the liquid component and/or renewable feedstock (e.g., 5 to 40 wt. %). In one embodiment, a sufficient amount of rework material is used for a slurry catalyst dosage ranging from 20 to 1000 ppm total active component to renewable feedstock in a slurry hydroprocessing system.

A (sulfided) slurry hydroprocessing catalyst can then be produced by sulfiding the slurry catalyst precursor. Sulfiding is generally carried out by contacting the slurry catalyst precursor with a sulfur-containing compound (e.g., elemental sulfur, hydrogen sulfide, polysulfides, or the like, or a combination thereof), which may originate from a fossil/mineral oil stream, from a renewable oil stream, from a combination thereof, or from a sulfur-containing stream separate from the aforementioned oil stream(s)) at a temperature and for a time sufficient to substantially sulfide the slurry catalyst precursor and/or sufficient to render the sulfided composition active as a hydroprocessing catalyst. For instance, the sulfidation can be carried out at a temperature from 300° C. to 400° C. (e.g., 310° C. to 350° C.) for a period of time from 30 minutes to 96 hours, (e.g., 1 hour to 48 hours or 4 hours to 24 hours). The sulfiding step can take place ex situ to the reactor in which the catalyst is to be used, in situ, or in a combination of ex situ and in situ to the reactor.

### Slurry Hydroprocessing

Slurry hydroprocessing provides a means for conversion of low value biomass feedstocks into higher value liquid products.

Slurry hydroprocessing can be carried out in a variety of known reactors of either up- or down-flow, it is particularly well suited to a bubble column reactor through which feed, catalyst and gas move upwardly. Hence, the outlet from slurry hydroprocessing reactor is above the inlet. One or more slurry hydroprocessing reactors may be utilized in parallel or in series. Other suitable reactors include continuously stirred-tank reactors or tubular reactors.

The slurry catalyst prepared as described herein may be added directly to the renewable feedstock in the slurry hydroprocessing reactor or may be mixed with the renewable feedstock prior to entering the reactor. The amount of catalyst can be no more than 2 wt. % (e.g., 0.5 to 2 wt. %) of the renewable feedstock.

In embodiments, the operating conditions for slurry hydroprocessing may include an operating temperature from 280° C. to 550° C. For example, the operating temperature may be from 300° C. to 400° C., or 300° C. to 500° C., or 300° C. to 550° C., or 350° C. to 450° C., or 400° C. to 500° C., or 400° C. to 550° C., or 450° C. to 500° C., or 500° C. to 550° C.

In embodiments, the operating conditions for slurry hydroprocessing may include a minimum hydrogen partial pressure from 2 MPa to 25 MPa. For example, the minimum hydrogen partial pressure may be from 2 MPa to 10 MPa, or 2 MPa to 15 MPa, or 2 MPa to 20 MPa, or 2 MPa to 25 MPa, or 5 MPa to 10 MPa, or 5 MPa to 15 MPa, or 5 MPa to 20 MPa, or 5 MPa to 25 MPa, or 10 MPa to 15 MPa, or 10 MPa to 20 MPa, or 10 MPa to 25 MPa, or 15 MPa to 20 MPa, or 15 MPa to 25 MPa, or 20 MPa to 25 MPa.

The operating conditions for slurry hydroprocessing may include a hydrogen feed rate from 500 standard liters of hydrogen to 1 liter of oil (StLt/L) to 2500 StLt/L. For example, the hydrogen feed rate may be from 500 to 1000 StLt/L, or 500 to 1500 StLt/L, or 500 to 2000 StLt/L, or 500 to 2500 StLt/L, or 1000 to 1500 StLt/L, or 1000 to 2000 StLt/L, or 1000 to 2500 StLt/L, or 1500 to 2000 StLt/L, or 1500 to 2500 StLt/L, or 2000 StLt/L to 2500 StLt/L.

Suitable liquid hourly space velocities (LHSV) for slurry hydroprocessing can range from about 0.05 h⁻¹ to 5 h⁻¹, such as 0.1 h⁻¹ to 2 h⁻¹.

Preferably, a sulfiding agent is continuously added to the slurry hydroprocessing reactor to renew the sulfide content of the catalyst. The sulfiding agent may be hydrogen sulfide or an organic sulfur-containing compound which decomposes to hydrogen sulfide in the slurry hydroprocessing reactor. Some suitable organic sulfur-containing compounds include methyl sulfides such as dimethyl sulfide (DMS) or dimethyl disulfide (DMDS), mercaptans, and polysulfides (e.g., di-tert-nonyl polysulfide).

The slurry hydroprocessing process uses a dispersed catalyst which is continuously doped into the renewable feedstock. This catalyst helps to suppress coke formation by capping free radicals formed by thermal conversion. Therefore, when a slurry hydroprocessing unit is operated once-through, the catalyst lifetime is equal to the feed residence time. This is economical because a very low concentration of catalyst is used. However, it is often desirable to increase the lifetime of the catalyst in order to reduce catalyst usage. Since it is difficult to isolate the catalyst from the product, this is most easily accomplished by bottoms recycle. Bottoms recycle increases the average catalyst lifetime. As a result, at constant make-up, the concentration of catalyst in the reactor liquid increases as bottoms recycle increases, even after accounting for reduced vaporization in the reactor. This allows the catalyst make-up rate to be reduced while maintaining equivalent coke suppression activity or, alternatively, the reactor severity can be increased while maintaining constant coke make.

The effluent from slurry hydroprocessing reactor(s) may be passed into one or more separation stages. For example, an initial separation stage can be a high pressure, high temperature (HPHT) separator. A higher boiling portion from the HPHT separator can be passed to a low pressure, high temperature (LPHT) separator while a lower boiling (gas) portion from the HPHT separator can be passed to a high temperature, low pressure (HTLP) separator. The higher boiling portion from the DPHT separator can be passed into a fractionator (e.g., an atmospheric fractionator).

The fractionator can be used to form a plurality of product streams, such as a light ends or C4-boiling range stream, one or more naphtha boiling range streams, one or more diesel and/or distillate (including kerosene) boiling range streams, and a bottoms fraction. The bottoms fraction can then be passed into vacuum fractionator to form, for example, a light vacuum gas oil, a heavy vacuum gas oil, and a bottoms or pitch fraction which typically boils above 450° C. Remaining catalyst particles from slurry hydroprocessing reactor(s) may be present in the bottoms fraction and may be conveniently recycled back to the slurry hydroprocessing reactor(s). Additionally or alternatively, catalyst particles in the bottoms fraction may be sent a solid/liquid separator.

### Renewable Feedstock

The renewable feedstock for slurry hydroprocessing is not particularly limited and may contain any combination of biomass-containing and/or biomass-derived feedstock.

As used herein, the term “biomass” generally refers to substances derived from organisms living above the earth's surface or within the earth's oceans, rivers, and/or lakes. Representative biomass can include any plant material, or mixture of plant materials, including woody biomass and agricultural and forestry products and residue, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, castor bean stalks, sugar cane bagasse, round wood, forest slash, bamboo, sawdust, sugarcane tops and trash, cotton stalks, corn cobs, Jatropha whole harvest, Jatropha trimmings, de-oiled cakes of palm, castor and Jatropha, coconut shells, residues derived from edible nut production and mixtures thereof, and sorghum, in addition to ‘on-purpose’ energy crops such as switchgrass, miscanthus, and algae. Short rotation forestry products, such as energy crops, include alder, ash, southern beech, birch, eucalyptus, poplar, willow, paper mulberry, Australian blackwood, sycamore, and varieties of paulownia elongate. Other examples of suitable biomass include organic oxygenated compounds, such as carbohydrates (e.g., sugars), alcohols, and ketones, as well as organic waste materials, such as wastepaper, construction, demolition wastes, and bio-sludge.

Organic oxygenated compounds of particular interest include those contained in triglyceride-containing components, for example naturally occurring plant (e.g., vegetable) oils and animal fats, or mixtures of such oils and fats (e.g., waste restaurant oils or grease). Triglyceride-containing components, which are representative of particular types of biomass, typically comprise both free fatty acids and triglycerides, with the possible additional presence of monoglycerides and diglycerides. Triglyceride-containing components may also include those comprising derivative classes of compounds such as fatty acid alkyl esters (FAAE), which embrace fatty acid methyl esters (FAME) and fatty acid ethyl esters (FAEE).

Examples of plant oils include algal oil, rapeseed (including canola) oil, camelina oil, castor oil, coconut oil, corn oil, colza oil, cottonseed oil, hempseed oil, jatropha oil, linseed oil, mustard oil, olive oil, palm oil, peanut oil, pennycress oil, rapeseed (including canola) oil, soybean oil, sunflower oil, and mixtures thereof. Examples of animal fats include lard, offal, tallow, train oil, milk fat, fish oil, sewage sludge, and/or recycled fats of the food industry, including various waste streams such as yellow and brown greases. Mixtures of one or more of these animal fats and one or more of these plant oils are also representative of particular types of biomass. The triglycerides and free fatty acids of a typical plant oil, animal fat, or mixture thereof, may include aliphatic hydrocarbon chains in their structures, with the majority of these chains having from about 8 to about 24 carbon atoms. Representative plant oils and/or animal fats, used as a triglyceride-containing component, may include significant proportions (e.g., at least 30%, or at least 50%) of aliphatic (e.g., paraffinic or olefinic) hydrocarbon chains with 16 and 18 carbon atoms. Triglyceride-containing components may be liquid or solid at room temperature.

A “biomass-containing” feedstock may comprise all or substantially all biomass, but may also contain non-biological materials (e.g., materials derived from petroleum, such as plastics, or materials derived from minerals extracted from the earth, such as metals and metal oxides, including glass) in significant quantities (e.g., at least 5% by weight, such as from 5% to 55% by weight, or at least 25% by weight, such as from 25% to 45% by weight). An example of a ‘biomass-containing’ feedstock that may comprise one or more non-biological materials is municipal solid waste (MSW). Such municipal solid waste may comprise any combination of lignocellulosic material (yard trimmings, pressure-treated wood such as fence posts, plywood), discarded paper and cardboard, food waste, textile waste, along with refractories such as glass, metal. Prior to use in the process of this disclosure, municipal solid waste may be optionally converted, after removal of at least a portion of any refractories, such as glass or metal, into pellet or briquette form. Co-processing of MSW with lignocellulosic waste is also envisaged. Certain food waste may be combined with sawdust or other material and, optionally, pelletized prior to use in the process of this disclosure.

“Biomass-derived”, for example when used in the phrase “biomass-derived feedstock”, refers to products resulting or obtained from the thermal and/or chemical transformation of biomass, as defined above, or biomass-containing feedstocks (e.g., MSW). Representative biomass-derived feedstocks therefore include, but are not limited to, products of pyrolysis (e.g. bio-oils), torrefaction (e.g. torrefied and optionally densified wood), hydrothermal carbonization (e.g. biomass that is pretreated and densified by acid hydrolysis in hot, compressed water), and polymerization (e.g., organic polymers derived from plant monomers). Other specific examples of biomass-derived products (e.g., for use as feedstocks) include black liquor, pure lignin, and lignin sulfonate. Biomass-derived feedstocks also extend to pretreated feedstocks that result or are obtained from thermal and/or chemical transformation, prior to, or upstream of, their use as feedstocks for a given conversion step.

The renewable feedstock encompasses feedstocks that are either liquid or solid at room temperature, or otherwise a solid-liquid slurry (e.g., crude animal fats containing solids).

In some embodiments, the renewable feedstock comprises a solid selected from the group consisting of lignocellulose, waste plastics, municipal solid waste, food waste, cellulosic feedstocks, aquaculture products, and combinations thereof.

The renewable feedstock may be any type of liquid biologically derived feedstock that can be usefully processed in a slurry hydroprocessing reactor. Examples of renewable feedstocks include lignocellulose derived feedstocks, such as liquid crude tall oil (CTO), tall oil pitch (TOP), crude fatty acid (CFA), tall oil fatty acids (TOFA) and distilled tall oil (DTO), liquefied lignocellulosic biomass, such as biocrudes as well as bio-oils obtained by various liquefaction techniques, such as fast pyrolysis (FP) or/and catalytic fast pyrolysis (CFP). Any combination of the renewable feedstocks can also be used.

“Crude tall oil” (CTO) is a generic term that applies to a complex mixture of tall oil fatty and resin acids most frequently obtained from the acidulation of crude tall oil soap via Kraft or sulfite pulping processes. Crude tall oil (CTO) comprises resin acids, fatty acids, and unsaponifiables. Resin acids are diterpene carboxylic acids found mainly in softwoods and typically derived from oxidation and polymerization reactions of terpenes. The main resin acid in crude tall oil is abietic acid but abietic derivatives and other acids, such as pimaric acid are also found. Fatty acids are long chain monocarboxylic acids and are found in hardwoods and softwoods. The main fatty acids in crude tall oil are oleic, linoleic and palmitic acids. Unsaponifiables cannot be turned into soaps as they are neutral compounds which do not react with sodium hydroxide to form salts. They include sterols, higher alcohols and hydrocarbons. Sterols are steroids derivatives which also include a hydroxyl group.

“Tall oil pitch” (TOP) is a residual bottom fraction from crude tall oil (CTO) distillation processes. Tall oil pitch typically comprises from 34 to 51 wt. % free acids, from 23 to 37 wt. % esterified acids, and from 25 to 34 wt. % unsaponifiable neutral compounds of the total weight of the tall oil pitch. The free acids are typically selected from a group consisting of dehydroabietic acid, abietic, other resin acids and free fatty acids. The esterified acids are typically selected from a group consisting of oleic and linoleic acids. The unsaponifiable neutral compounds are typically selected from a group consisting of triterpene sterols, fatty alcohols, sterols, and dehydrated sterols.

“Crude fatty acid” (CFA) is a fatty acid-containing materials obtainable by fractionation (e.g., distillation under reduced pressure, extraction, and/or crystallization) of CTO. Crude fatty acid (CFA) can also be defined as combination of fatty acids containing fractions of crude tall oil distillation i.e. tall oil heads (TOH), tall oil fatty acid (TOFA) and distilled tall oil (DTO).

“Tall oil fatty acid” (TOFA) is a fatty acid rich fraction of crude tall oil (CTO) distillation processes. TOFA typically comprises mainly fatty acids, typically at least 80 wt. % of the total weight of the TOFA. Typically, TOFA comprises less than 10 wt. % resin acids.

“Distilled tall oil” (DTO) is a complex mixture of mainly fatty acids and resin acids fraction of crude tall oil (CTO) distillation processes. DTO typically comprises mainly fatty acids, typically from 55 to 90 wt. %, and resin acids, typically from 10 to 40 wt. % resin acids, of the total weight of the DTO. Typically, DTO comprises less than 10 wt. % unsaponifiable neutral compounds of the total weight of the distilled tall oil.

“Bio-oil” refers to pyrolysis oils produced from biomass by employing pyrolysis. Biomass is a material derived from recently living organisms, which includes plants, animals and their byproducts. Pyrolysis refers to thermal decomposition of materials at elevated temperatures in a non-oxidative atmosphere.

“Biocrude” refers to oils produced from biomass by employing hydrothermal liquefaction. Hydrothermal liquefaction (HTL) is a thermal depolymerization process used to convert wet biomass into crude-like oil under moderate temperature and high pressure.

“Lignocellulosic biomass” refers to biomass derived from plants or their byproducts. Lignocellulosic biomass is composed of carbohydrate polymers (cellulose, hemicellulose) and an aromatic polymer (lignin). “Liquefied lignocellulosic biomass” refers to biocrudes as well as bio-oils obtained by various liquefaction techniques, such as hydrothermal liquefaction” (HTL), fast pyrolysis (FP) and catalytic fast pyrolysis (CFP). Fast pyrolysis is a thermochemical decomposition of biomass through rapid heating in an absence of oxygen.

Examples of bio-oil and biocrude produced from lignocellulosic biomass (e.g., materials like forest harvesting residues or byproducts of a sawmill) are lignocellulosic pyrolysis liquid (LPL), produced by employing fast pyrolysis, and HTL-biocrude, produced by employing hydrothermal liquefaction.

1. A method for preparing a slurry catalyst for use in upgrading a renewable feedstock, comprising:
(a) providing a rework material obtained from a process of making a self-supported hydroprocessing catalyst, the hydroprocessing catalyst containing one or more active metal components selected from the group consisting of Group 6-12 metals from the IUPAC Periodic Table of the Elements, wherein the rework material has an average particle size of from 1 to 300 μm;
(b) mixing the rework material with a liquid component to form a slurry catalyst precursor, wherein the liquid component is selected from the renewable feedstock and a liquid carrier, wherein the liquid carrier is a polyol and/or a recycled renewable feedstock comprising heavy and/or unconverted fractions from a slurry hydroprocessing process; and
(c) sulfiding the slurry catalyst precursor forming the slurry catalyst.

2. The method of claim 1, the active metal component of the self-supported hydroprocessing catalyst is selected from the group consisting of molybdenum, tungsten, iron, nickel, cobalt, zinc, and combinations thereof.

3. The method of claim 1, wherein the active metal component of the self-supported hydroprocessing catalyst is a combination of active metal components selected from the group consisting of nickel-tungsten, nickel-molybdenum, nickel-molybdenum-tungsten, cobalt-molybdenum, and iron-zinc.

4. The method of claim 1, wherein the self-supported hydroprocessing catalyst further comprises 0.5 wt. % to 20 wt. % of a binder.

5. The method of claim 1, wherein the rework material is obtained by grinding the self-supported hydroprocessing catalyst to an average particle size of from 1 to 300 μm.

6. The method of claim 5, wherein the grinding is by any of wet grinding and dry grinding.

7. The method of claim 1, wherein the rework material comprises catalyst products, scrap pieces, fines, and/or rejected materials obtained from a process of making a calcined self-supported hydroprocessing catalyst.

8. The method of claim 1, wherein the rework material is a rework material mixture comprising a fresh self-supported hydroprocessing catalyst and a ground spent self-supported hydroprocessing catalyst.

9. The method of claim 8, wherein a weight ratio of ground spent self-supported hydroprocessing catalyst to fresh self-supported hydroprocessing catalyst is in a range from 1:99 to 10:90.

10. The method of claim 1, wherein the rework material is a rework material mixture comprising a self-supported hydroprocessing catalyst and a ground supported hydroprocessing catalyst.

11. The method of claim 10, wherein a weight ratio of ground supported hydroprocessing catalyst to self-supported hydroprocessing catalyst is in a range from 1:99 to 10:90.

12. The method of claim 1, wherein the rework material has an average particle size of from 2 to 100 μm.

13. The method of claim 1, wherein the rework material has a total pore volume of from 0.1 to 1.2 cm³/g and/or a BET specific surface area of from 30 to 500 m²/g.

14. The method of claim 1, wherein the rework material is mixed with the liquid component in an amount of from 5 to 40 wt. % of total weight of the liquid component.

15. The method of claim 1, wherein the renewable feedstock comprises crude tall oil, tall oil pitch, crude fatty acid, tall oil fatty acid, distilled tall oil, liquefied lignocellulosic biomass, bio-oil, biocrude, or a combination thereof.

16. The method of claim 1, wherein the polyol is selected from the group consisting of ethylene glycol, diethylene glycol, triethylene glycol, polyethylene glycol, propylene glycol, dipropylene glycol, tripropylene glycol polypropylene glycol, butylene glycol, propanediol, butanediol, glycerol, and combinations thereof.

17. A process for upgrading a renewable feedstock, the process comprising:
(a) contacting in a slurry hydroprocessing unit the renewable feed with a slurry catalyst composition comprising:
(i) a rework material obtained from a process of making a self-supported hydroprocessing catalyst, the hydroprocessing catalyst containing one or more active metal components selected from the group consisting of Group 6-12 metals from the IUPAC Periodic Table of the Elements, wherein the rework material has an average particle size of from 1 to 300 μm, and
(ii) a liquid component, wherein the liquid component is selected from the renewable feedstock and a liquid carrier, wherein the liquid carrier is a polyol and/or a recycled renewable feedstock comprising heavy and/or unconverted fractions from a slurry hydroprocessing process; and
(b) hydroprocessing the renewable feed in the slurry hydroprocessing unit to produce an upgraded renewable feed.

18. The process of claim 17, wherein a sulfiding agent is continuously introduced to the slurry hydroprocessing unit.

19. The process of claim 17, wherein the active metal component of the self-supported hydroprocessing catalyst is selected from the group consisting of molybdenum, tungsten, iron, nickel, cobalt, zinc, and combinations thereof.

20. The process of claim 17, wherein the active metal component of the self-supported hydroprocessing catalyst is a combination of active metal components selected from the group consisting of nickel-tungsten, nickel-molybdenum, nickel-molybdenum-tungsten, cobalt-molybdenum, and iron-zinc.

21. The process of claim 17, wherein the rework material is a rework material mixture comprising a fresh self-supported hydroprocessing catalyst and a ground spent self-supported hydroprocessing catalyst.

22. The process of claim 21, wherein a weight ratio of ground spent self-supported hydroprocessing catalyst to fresh self-supported hydroprocessing catalyst is in a range from 1:99 to 10:90.

23. The process of claim 17, wherein the rework material is a rework material mixture comprising a self-supported hydroprocessing catalyst and a supported hydroprocessing catalyst.

24. The method of claim 23, wherein a weight ratio of ground supported hydroprocessing catalyst to self-supported hydroprocessing catalyst is in a range from 1:99 to 10:90.
